(19) United States
(12) Patent Application Publication
(10) Pub. No.: US 2022/0405341 A1
(43) Pub. Date: Dec. 22, 2022

(54) ARTICLE DISPLAY PROCESSING METHOD AND APPARATUS AND ELECTRONIC DEVICE

(71) Applicant: ALIBABA GROUP HOLDING LIMITED, GEORGE TOWN (KY)

(72) Inventors: Chenzhe XIAO, Hangzhou (CN); Jiajia DENG, Hangzhou (CN); Xing TANG, Hangzhou (CN); Mei HE, Hangzhou (CN); Mengwei WANG, Hangzhou (CN); Xi GUO, Hangzhou (CN); Chengyue JIA, Hangzhou (CN); Jingjing ZHU, Hangzhou (CN); Lincheng ZENG, Hangzhou (CN)

(21) Appl. No.: 17/891,540

(22) Filed: Aug. 19, 2022

Related U.S. Application Data
(63) Continuation of application No. PCT/CN2021/075938, filed on Feb. 8, 2021.

(30) Foreign Application Priority Data
Feb. 20, 2020 (CN) 202010105327.0

(51) Int. Cl. G06F 16/9538; G06F 16/957

(52) U.S. Cl. CPC G06F 16/9538; G06F 16/9577

(57) ABSTRACT

Embodiments of this application provide an article display processing method and apparatus and an electronic device. An exemplary method includes: displaying a plurality of articles on a webpage, each of the plurality of articles being associated with an user interface; receiving a user selection of the user interface associated with a selected article from a first user; obtaining an environment template corresponding to the selected article, wherein the environment template is a digitally-generated simulated environment and stored in a database; generating a display image comprising the environment template fused with the selected article as a main view angle according to feature data of the selected article; and sending the display image to a client device of the first user for display.

### CROSS-REFERENCE TO RELATED APPLICATIONS

This application is a continuation application of International Patent Application No. PCT/CN2021/075938, filed Feb. 8, 2021, which claims priority to Chinese Patent Application No. 202010105327.0, filed with the China National Intellectual Property Administration on Feb. 20, 2020 and entitled “ARTICLE DISPLAY PROCESSING METHOD AND APPARATUS AND ELECTRONIC DEVICE.” The entire contents of all of the above referenced applications are incorporated herein by reference.

### TECHNICAL FIELD

This application discloses an article display processing method and apparatus and an electronic device, and belongs to the field of computer technologies.

### BACKGROUND

In the environment of online shopping, such as furniture online shopping, it is difficult for a user to determine whether a furniture to be purchased would match a set environment before physically receiving the furniture. Oftentimes the users may find that the received furniture does not fit well with the settings of the space as they expected. After these cases happen, unnecessary costs of returning and exchanging are incurred, resulting in poor shopping experience for the users.

### SUMMARY

Embodiments of this application provide an article display processing method and apparatus, to improve a display effect of displaying an article online.

In some aspects, the techniques described herein relate to an article display processing method, including: displaying a plurality of articles on a webpage, each of the plurality of articles being associated with an user interface; receiving a user selection of the user interface associated with a selected article from a first user; obtaining an environment template corresponding to the selected article, wherein the environment template is a digitally-generated simulated environment and stored in a database; generating a display image including the environment template fused with the selected article as a main view angle according to feature data of the selected article; and sending the display image to a client device of the first user for display.

In some aspects, the method further includes: updating the display image when the first user changes the feature data of the selected article and/or the environment template, and displaying the updated display image.

In some aspects, the method further includes: selecting, in response to a configuration operation of a second user on an article, one or more environment templates as environment templates matched with the article from an environment template database, wherein the environment templates respectively correspond to a plurality of different environment element combinations.

In some aspects, the method further includes: after the one or more environment templates are selected as the environment templates matched with the article, generating a rendering file by fusing the article and each of the environment templates, and wherein the generating a display image including the environment template fused with the selected article as a main view angle according to feature data of the selected article includes: generating the display image with the selected article as the main view angle according to the feature data of the selected article, the environment template, and the rendering file.

In some aspects, the obtaining an environment template corresponding to the selected article includes: determining, according to the selected article, matched environment templates corresponding to the selected article; and selecting the environment template from the matched environment templates for displaying the selected article.

In some aspects, the method further includes: obtaining a new environment template in response to a change operation of the first user on one or more environment elements in the environment template, and displaying the selected article based on the new environment template, wherein the change operation on each of the one or more environment elements is performed within a corresponding range pre-configured by the second user.

In some aspects, the environment elements include hard furnishing environment elements and soft furnishing environment elements.

In some aspects, the environment template includes an additional article different from the selected article, and the method further includes: displaying a display interface corresponding to the additional article in response to a selection operation of the first user on the additional article, and displaying a display image with the additional article as a main view angle in the display interface.

In some aspects, the method further includes: rendering the additional article with feature data determined based on the feature data of the selected article.

In some aspects, the rendering includes: determining a color of the additional article based on a color of the selected article according to one or more predefined color schemes.

In some aspects, the webpage is displayed on the client device, and the sending the display image to a client device of the first user for display includes: generating a floating window on top of the webpage on the client device; and displaying the display image in the floating window.

In some aspects, the webpage is displayed on a first client device, and the sending the display image to a client device of the first user for display includes: sending the display image to a second client device for display, wherein the second client device is different from the first client device.

In some aspects, the techniques described herein relate to a non-transitory computer-readable storage medium configured with instructions executable by one or more processors to cause the one or more processors to perform operations including: displaying a plurality of articles on a webpage, each of the plurality of articles being associated with an user interface; receiving a user selection of the user interface associated with a selected article from a first user; obtaining an environment template corresponding to the selected article, wherein the environment template is a digitally-generated simulated environment and stored in a database; generating a display image including the environment template fused with the selected article as a main view angle according to feature data of the selected article; and sending the display image to a client device of the first user for display.

In some aspects, the techniques described herein relate to a system including one or more processors and one or more non-transitory computer-readable storage media storing instructions executable by the one or more processors to cause the system to perform operations including: displaying a plurality of articles on a webpage, each of the plurality of articles being associated with an user interface; receiving a user selection of the user interface associated with a selected article from a first user; obtaining an environment template corresponding to the selected article, wherein the environment template is a digitally-generated simulated environment and stored in a database; generating a display image including the environment template fused with the selected article as a main view angle according to feature data of the selected article; and sending the display image to a client device of the first user for display.

The foregoing description is merely an overview of the technical solutions of this application. To understand the technical means of this application more clearly, implementation can be performed according to content of the specification. Moreover, to make the foregoing and other objectives, features, and advantages of this application more comprehensible, implementations of this application are particularly described below.

### BRIEF DESCRIPTION OF THE DRAWINGS

FIG. 1 is a schematic diagram of an application scenario of an article display processing technology, according to an embodiment of this application.

FIG. 2 is a first schematic flowchart of an article display processing method, according to an embodiment of this application.

FIG. 3 is a second schematic flowchart of an article display processing method, according to an embodiment of this application.

FIG. 4 is a first schematic structural diagram of an article display processing apparatus, according to an embodiment of this application.

FIG. 5 is a second schematic structural diagram of an article display processing apparatus, according to an embodiment of this application.

FIG. 6 is a schematic structural diagram of an electronic device, according to an embodiment of this application.

### DETAILED DESCRIPTION

The following describes in detail exemplary embodiments of the present disclosure with reference to the accompanying drawings. Although the accompanying drawings show the exemplary embodiments of this application, it should be understood that this application may be implemented in various manners and is not limited by the embodiments described herein. Rather, these embodiments are provided, so that this application is more thoroughly understood and the scope of this application is completely conveyed to a person skilled in the art.

With the development of network technologies, life and work are increasingly carried out online. In some scenarios, people do not have access to real articles, but hope to be able to see a display effect of the articles online, especially a matching effect of the articles with physical surroundings. Such a need is common for online shopping. Before making a purchase, a buyer wants to better examine whether an article would match the surroundings and whether an expected effect is presented when the article is placed in a target environment. To purchase furniture online, for example, the furniture is typically large. If the furniture is bought and placed in the home, and it is later found that the furniture does not match the environment, returning and exchanging the furniture is costly and difficult. Therefore, if a display effect of the furniture in a home environment can be observed in advance via an online display, a better purchasing decision may be made to reduce the probability of problems after the furniture arrives.

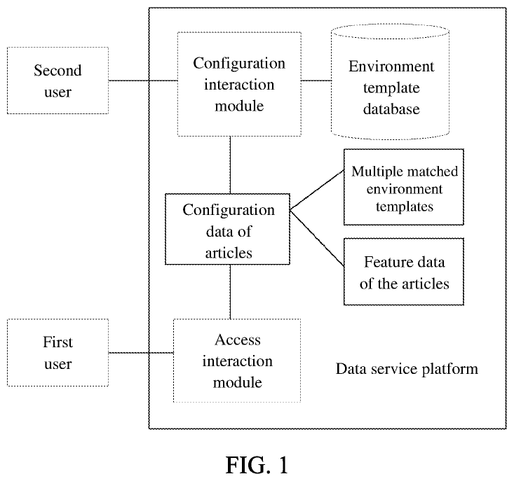

An embodiment of this application provides an article display processing technology to meet the foregoing requirement. Based on pre-configured environment templates, an article display image in which environment elements are fused is generated in combination with user-selected online articles. The displayed article is positioned at a main view angle in the display image, allowing the user to completely observe a matching effect of the article with the environment. FIG. 1 is a schematic diagram of an application scenario of an article display processing technology, according to an embodiment of this application. The technology may be implemented on a cloud-based data service platform. The data service platform may be a platform that provides e-commerce services or a platform that provides other article display services, or the like. The data service platform may be pre-configured with a database having various environment templates, and may perform fusion and rendering process on a to-be-displayed article and an environment template. The data service platform may provide an access service to a first user (i.e., a visitor of an article display) through an access interaction module shown in the figure executes the function. In addition, the data service platform may also provide a data configuration service for configuring a to-be-displayed article and an environment template to a second user (i.e., a provider of the article display) through a configuration interaction module shown in the figure. After the second user configures an article, configuration data corresponding to the article may be generated and stored in the data service platform. The configuration data mainly includes feature data of the article and a plurality of environment templates that match the article. When the first user accesses the to-be-displayed article, the data service platform generates a display image according to the configuration data. In an exemplary environment such as E-commerce, the first user may be a user as a customer or a buyer, and the second user may be a user as a merchant or a seller.

The environment templates and a matching relationship between articles and the environment templates may be pre-configured. Each article may be configured with a plurality of environment templates, and the environment template is formed by combining a plurality of environment elements. Different environment templates are different environment element combinations. The second user may select an environment template adapted to a to-be-displayed article from an environment template database provided by the data service platform and establish a mapping relationship. In addition, the second user may select one environment template from the plurality of configured environment templates as a default environment template for initially displaying an article selected by the first user. When viewing an article display, the first user may change environment elements in the environment templates, or switch between different environment templates. Because the environment template or matching of the environment template with the article is pre-configured, the rendering processing may be performed in advance so that the article can be displayed with high efficiency when the user switches the display of articles and the display of templates online. The environment elements may include hard furnishing elements and soft furnishing elements. The hard furnishing elements include, for example, a type and a size of a house, material and color of a wall, and material and color of a floor. The soft furnishing elements include surrounding articles around a displayed article. For example, if the displayed article is a sofa, the surrounding articles may include a coffee table, a floor lamp, household appliances, and the like. In addition, feature data of the displayed article may include color, a size, and an appearance of the article. The feature data may also be changed online by the first user. For instance, a merchant may pre-configure furniture with optional feature data, for example, pre-configuring sofas of a plurality of models, and provide some color and size options. A buyer may change the feature data within a range configured by the merchant while browsing the display. The merchant may pre-configure environment templates, and pre-render the images with the environment templates fused with articles of different feature data. Each of the pre-rendered images includes one environment template fused with a main article rendered with one set of feature data in the focus of the image (e.g., a main view angle). In some embodiments, the environment template may include additional (surrounding) articles that the second user sells. The additional articles may be displayed with default feature configurations (e.g., color, size). In some embodiments, the feature data of these additional articles may be automatically adjusted according to the set of feature data of the main article. For instance, based on the color setting of the main article, the colors of the additional articles in the environment template may be configured according to predefined color schemes (e.g., monochromatic, analogous, complementary, split complementary, triadic, square, and rectangle (or tetradic)). Similar, based on the size or shape setting of the main article, the sizes or shapes of the additional articles may be adjusted accordingly. A user may change both the environment template and feature parameters of the article within the corresponding pre-configured ranges. Since the merchant has pre-processed/pre-generated all combinations of the environment templates and the articles with available feature parameters, the user selected combination may be displayed rapidly.

In some embodiments, an article selected by the first user is displayed at a main view angle in the displayed image, allowing the first user to more intuitively view a display effect of the article in an environment. In addition, because an environment template corresponding to a to-be-display article is pre-configured, the article and the environment template may be fused and rendered in advance, allowing the first user to obtain a more efficient online effect display.

In addition, when the first user views a display image of an article, it is possible that the first user is interested in an element (another article) in the displaying environment (e.g., from a current environment template). In this case, the first user may want to switch the display to focus on the other article corresponding to the element in the displaying environment. If the second user pre-configures an environment template for the other article, a user interface with the other article as a to-be-displayed article may be displayed, and a display image with the other article as a main view angle combined with the corresponding environment template may be generated.

In another implementation, after the first user has selected an article, the first user is presented with an interaction interface for configuring any one or more of feature data of the article, an environment template, and an article observation view angle. The interaction interface provides the user with a plurality of options for these aspects, allowing the user to configure a feature of the article, an environment element, and an observation view angle according to requirements, thereby achieving an article display effect that better meets the requirements of the user.

In addition, the technical solution of this embodiment of this application may be further extended. In the interaction interface displayed to the user for displaying articles, prices of a plurality of articles displayed in a display environment may be counted, so that an overall quotation of the plurality of displayed articles in the display environment is displayed to the user. Alternatively, the user may select a plurality of displayed articles in a display environment and then generate a total quotation. For example, a total quotation is performed after a sofa, a coffee table, a carpet, cushions on the sofa, and tea sets on the coffee table are displayed. Such a display interaction method helps provide the user with a combination of a product display and a sales mode. In addition, other similar products may be further recommended according to a style of a product selected by the user for display, to provide the user with an alternative choice that meets the requirements of the user. For instance, after a user temporarily selects a simple style coffee table, the data service platform may find similar coffee table pictures according to the style of the coffee table and display the coffee table pictures to the user, and the user may replace the recommended coffee table in the environment for display and comparison.

In addition, the user may further send or share a generated display image in which the article is incorporated into the environment through social media, instant messaging software, or an e-mail, thereby achieving an information transfer and sharing display effect.

The technical solution of this application is further described by using some specific embodiments below.

### Embodiment 1

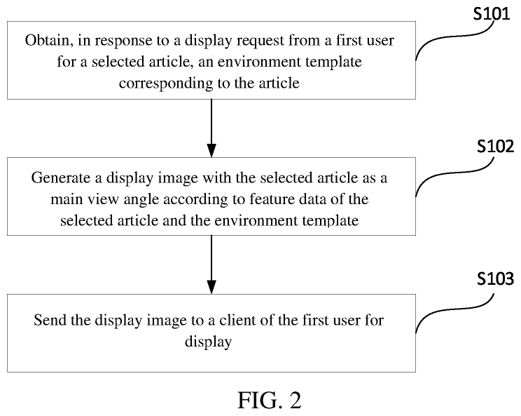

FIG. 2 is a first schematic flowchart of an article display processing method, according to an embodiment of this application. The method is applicable to a data service platform that provides an article display service. Both article-related data and display environment-related data are stored in the data service platform. The data service platform may process image data, fuse and render an article and an environment template, and send a generated display image to a client accessing the data service platform. Specifically, the method includes the following steps.

S101. Obtain, in response to a display request from a first user for a selected article, an environment template corresponding to the article. The display request may be triggered by an operation by the first user on an access interaction interface provided by the data service platform for the article. The access interaction interface may be a webpage that displays article information. For example, to sell furniture online, the first user, as a buyer, visits a page of a furniture product, and the page has related introduction information, price information, pictures of the product. In addition, function buttons such as buttons for adding products to a shopping cart, buying products, and adding products to favorites are also displayed in the webpage. In addition, in this embodiment of this application, a button for environment display may be further provided. When the first user clicks/taps the button, the display request is triggered to jump to a display interface in which the article is displayed in a simulated environment using an environment template. The simulated environment is a digitally-generated simulation environment with a plurality of digital features.

The environment template may include a plurality of environment elements. Using an indoor environment as an example, the environment elements may include hard furnishing environment elements and/or soft furnishing environment elements. The hard furnishing elements include, for example, a type and a size of a house, material and color of a wall, and material and color of a floor. The soft furnishing elements include surrounding articles around a displayed article, for example, if the displayed article is a sofa, the surrounding articles may include a coffee table, a floor lamp, household appliances, and the like.

In this embodiment of this application, the environment template may be pre-configured by a second user as a provider of article display. The data service platform may provide a database that stores a large quantity of environment templates for the second user to perform selection, as well as an interaction interface for configuring a corresponding environment template. Therefore, the method may further include: selecting, in response to a configuration operation of a second user on an article, one or more environment templates as environment templates matched with the article from an environment template database, where the environment templates respectively correspond to a plurality of different environment element combinations. After the one or more environment templates are selected as the environment templates matching with the article, rendering files fusing the article and the environment templates may be further generated and used for generating display images according to a requirement of the second user. The processing may be generally performed as a pre-configuration operation (offline operation). That is, before a to-be-displayed article is released, the article and a corresponding environment template are pre-configured and pre-processed/pre-rendered. One environment template of the environment templates matched with the to-be-displayed article and configured by the second user may be specified as a default environment template. When receiving the display request from the first user, the data service platform may directly invoke the default environment template to perform subsequent processing. In addition, the second user may alternatively not set a default environment template, but the data service platform randomly selects an environment template.

S102. Generate a display image according to feature data of the selected article and the environment template with the selected article as a main view angle. The feature data of the article may include color, a size, an appearance, and the like of the article. The feature data of the article may be included in the display request. In some cases, the feature data of the article may be determined based on an article identifier included in the display request. The data service platform may invoke the feature data corresponding to the article according to the article identifier (e.g., an article number). In this step, image synthesis processing is performed according to the feature data of the article and the environment template. In the generated display image, the displayed article is positioned at the main view angle, allowing the user to fully observe a matching effect of the article within the environment. The main view angle described herein refers to that the article is located at a core position of the environment or a focal position of the visual picture, and a main objective thereof is to allow the user to better observe, with the article in the center, an effect after the article is fused with the environment. Further, as described above, the second user may pre-configure a combination relationship between the environment templates and the article and build the rendering file by fusing the article and the environment templates. This way, in step S102, the display image with the selected article as the main view angle may be generated according to the feature data of the selected article, the environment template, and the rendering file.

In some embodiments, the rendering file generated when the second user performs pre-configuration may be generated by performing rendering processing based on basic feature data of an article and an environment template. The rendering file may be pre-stored as an intermediate file in configuration data related to the article. Because the feature data of the article may include a plurality of factors such as a size, color, and a material, after the second user selects a specific set of feature data of the article, a final display image is generated according to specific set of feature data of the article and a previously pre-generated rendering file (e.g., the intermediate file).

S103. Send the display image to a terminal device of the first user for display. After generating a display image, the data service platform may send the display image to a terminal device of the first user and display the display image in a responsive display interface.

After viewing the display image fused with the environment template in the display interface, the first user may perform a change operation on environment elements in the environment template. In response to the first user's change operation, the data service platform obtains a new environment template, and displays the selected article based on the new environment template, that is, performing step S102 and step S103 again. For example, a displayed article is a sofa. The first user may replace soft furnishing elements such as a matched coffee table and carpet or replace hard furnishing elements such as color of a wall and a size of a room. In the display interface, the change operation of the first user on the environment elements may be limited in a range of matched environment templates pre-configured by the second user. In some embodiments, since the environment templates with all combinations of the soft furnishing elements and hard furnishing elements are fused and rendered in advance, a new display image can be quickly generated in response to the change operation of the first user. In addition, the first user may also change the feature data such as color and a size of the article, and a display image is generated and displayed based on new feature data and the new environment template.

In addition, articles other than the displayed main article (e.g., the article selected by the first user and displayed in the center of the image) may also be involved in the environment template. These articles may have a correlation with the displayed article. That is, environment elements in the environment template may also become main articles. For instance, if the first user is interested in another article in the environment when viewing a currently displayed main article, and the first user may hope to view an effect of the other article in a virtual environment again, the first user may perform a selection operation on the other article in a current display interface. In response, the data service platform may render a display interface corresponding to the other article, and display a display image with the other article as a main view angle in the display interface. In the process, the data service platform essentially starts another processing process. The other article selected by the user is used as a to-be-displayed main article, and processing of step S101 to step S103 is performed. Still using online furniture display as an example, a merchant, as the second user, uses a sofa as a displayed article. When the first user views the sofa, a coffee table is configured in an environment template, and the coffee table may adopt an appearance of a coffee table being sold by the second user. If the first user is also interested in the coffee table, the first user may trigger a display process of the coffee table by clicking/tapping the coffee table in a display interface. In a new display process, the coffee table, as the new main article, is displayed in a display image at a main view angle.

According to the article display processing method provided in this embodiment of this application, a to-be-displayed article is fused with a preset environment template for article display, allowing a user to efficiently observe a display effect of the article in an environment. In addition, in a generated display image, the displayed article is used as a first view angle, allowing the user to more intuitively and completely observe a display state of the article in the environment.

### Embodiment 2

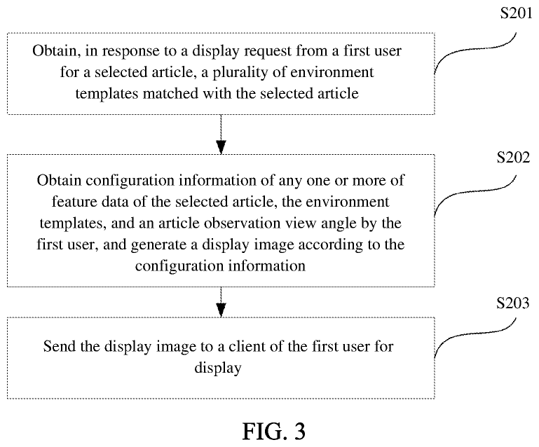

FIG. 3 is a second schematic flowchart of an article display processing method, according to an embodiment of this application. The method is similarly applicable to a data service platform that provides an article display service. A difference from Embodiment 1 lies in that after a display request from a first user is received, a plurality of matched environment templates configured by a second user are invoked for a first user to perform selection, and after the first user performs a selection operation, a display image is generated. Specifically, the method includes the following steps.

S201. Obtain, in response to a display request from a first user for a selected article, a plurality of environment templates matched with the selected article. As described in the foregoing embodiment, the plurality of matched environment templates are pre-configured by the second user.

S202. Obtain configuration information of any one or more of feature data of the selected article, the environment templates, and an article observation view angle by the first user, and generate a display image according to the configuration information. In this embodiment, before a final display image is generated, the first user performs a setting operation on the dimensions of the feature data of the article, the environment templates, and the article observation view angle. The first user may select the feature data of the article and the environment templates within a range pre-configured by the second user. For the observation view angle, the second user may also pre-configure a plurality of rendering files that show a combination of each environment template and the article from several different view angles based on a process of pre-configuring the environment templates. Correspondingly, the first user may also select the observation view angle within a range configured by the second user. However, in another implementation, the observation view angle may be changed through online image processing of the data service platform. The second user may configure the environment templates for only the main view angle. If the first user selects another observation view angle, the data service platform performs online image change to generate a corresponding display image.

S203. Send the display image to a client device of the first user for display. The step is the same as processing in Embodiment 1.

According to the article display processing method of this embodiment of this application, a to-be-displayed article is fused with a preset environment template for article display, allowing a user to efficiently observe a display effect of the article in an environment. In addition, in this embodiment, before a display image is generated, dimensions of feature data of the article, environment templates, and an article observation view angle are configured by a first user, so that the first user selects, in a more targeted manner, an environment template that meets a requirement of the first user, to achieve a better display effect.

### Embodiment 3

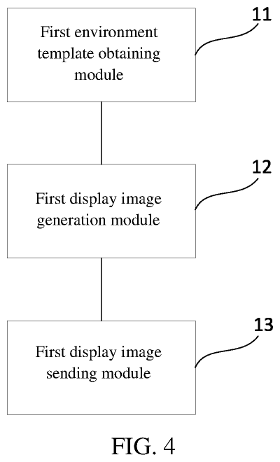

FIG. 4 is a first schematic structural diagram of an article display processing apparatus, according to an embodiment of this application. The apparatus may be disposed on the data service platform. Specifically, the apparatus may include the following modules.

A first environment template obtaining module 11 is configured to obtain, in response to a display request from a first user for a selected article, an environment template corresponding to the article. The display request may be triggered by an operation by the first user on an access interaction interface provided by the data service platform for the article.

A first display image generation module 12 is configured to generate a display image with the selected article as a main view angle according to feature data of the selected article and the environment template.

A first display image sending module 13 is configured to send the display image to a client of the first user for display.

The foregoing modules may correspond to the access interaction module for the first user in FIG. 1. Article display interaction with the first user is completed by using the foregoing modules, and a display image of the article in an environment is provided to the first user. In addition, after viewing the display image fused with the environment template in a display interface, the first user may perform a change operation on environment elements, to trigger the first display image generation module 12 to generate a display image.

In addition, the environment template may be pre-configured by a second user as a provider of article display. Correspondingly, the apparatus may further include the following modules.

A configuration interaction module is configured to select, in response to a configuration operation of a second user on an article, one or more environment templates as environment templates matched with the article from an environment template database, where the environment templates respectively correspond to a plurality of different environment element combinations. After the second user selects the one or more environment templates as the environment templates matched with the article, a rendering file fusing the article and the environment templates may be further generated and used for the first display image generation module 12 to generate the display image according to a requirement of the second user.

A detailed description of the processing process, a detailed description of the technical principles, and a detailed analysis of the technical effect are made in the foregoing embodiments. Details are not described herein again.

According to the article display processing apparatus provided in this embodiment of this application, a to-be-displayed article is fused with a preset environment template for article display, allowing a user to efficiently observe a display effect of the article in an environment. In addition, in a generated display image, the displayed article is used as a first view angle, allowing the user to more intuitively and completely observe a display state of the article in the environment.

### Embodiment 4

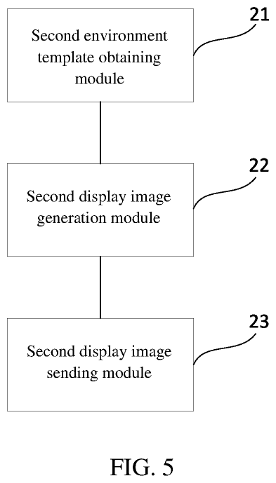

FIG. 5 is a second schematic structural diagram of an article display processing apparatus, according to an embodiment of this application. The apparatus is similarly disposed on the data service platform. A difference from Embodiment 3 lies in that after receiving a display request from a first user, the apparatus invokes a plurality of matched environment templates configured by a second user for a first user to perform selection, and after the first user performs a configuration operation, a display image is generated. Specifically, the apparatus may include the following modules.

A second environment template obtaining module 21 is configured to obtain, in response to a display request from a first user for a selected article, a plurality of environment templates matched with the selected article. As described in the foregoing embodiment, the plurality of matched environment templates are pre-configured by the second user.

A second display image generation module 22 is configured to obtain configuration information of any one or more of: feature data of the selected article, the environment templates, and an article observation view angle from the first user, and generate a display image according to the configuration information. In the processing of the second display image generation module 22 of this embodiment, before a final display image is generated, the first user performs a setting operation on the dimensions of the feature data of the article, the environment templates, and the article observation view angle. The first user may select the feature data of the article and the environment templates within a range pre-configured by the second user. For the observation view angle, the second user may pre-generate the rendering files of several view angles for a combination of each environment template and the article based on a process of pre-configuring the environment templates. Correspondingly, the first user may select the observation view angle within a range configured by the first user. However, in another implementation, the observation view angle may be changed through online image processing of the data service platform. The second user may configure the environment templates for only the main view angle. If the first user selects another observation view angle, the data service platform performs online image change to generate a corresponding display image.

A second display image sending module 23 is configured to send the display image to a client of the first user for display.

According to the article display processing apparatus of this embodiment of this application, a to-be-displayed article is fused with a preset environment template for article display, allowing a user to efficiently observe a display effect of the article in an environment. In addition, in this embodiment, before a display image is generated, dimensions of feature data of the article, environment templates, and an article observation view angle are configured by a first user, so that the first user selects, in a more targeted manner, an environment manner that meets a requirement of the first user, to achieve a better display effect.

### Embodiment 5

This embodiment provides an article display processing method, which is applicable to an application in an e-commerce platform for displaying products to users. For example, a store sales page may display information such as product names, pictures, prices, and details about products sold online. A “product display” button or another form of user interface may be set in the page. After a user clicks/taps the button, another product display page may be popped up as a floating window on top of the original page, so that a product is displayed in a simulated environment, to allow the user to better observe a display effect of the product. In some embodiments, a click/tap on the button will open a new product display page. In other embodiments, the page with the “product display” button may be displayed on a first device, and the product display page may be displayed on a second device (e.g., a user may click the button on a page displayed on a computer display, and the rendered product display page may be transmitted to the user's cellphone for display). Specifically, the article display processing method may include the following steps.

S301. Trigger, in response to a first operation of a user in a first article display interface for displaying basic article information, a second article display interface for displaying a state of an article in a display environment. Here, the display environment is a simulated environment with digital environmental elements. For example, the user performs some operations (for example, clicking/tapping the “product display” button) on an interface (for example, the mentioned product sales page) for displaying the basic article information, to jump to another display interface for displaying a state of the article placed in the simulated environment.

S302. Load original image data of the article and one or more environment templates. As the second article display interface being triggered, the original image data of the article and some preset environment templates are loaded for the user to perform selection. The user may select different environment templates as the environment template matched with the article.

S303. Determine an attribute feature of the article and a selected environment template in response to a configuration operation of the user in the second article display interface. The user performs various configurations in the second article display interface, for example, configuring attribute features such as a size, color, and a model of the article. The configuration options available for the user may be pre-configured by a merchant in the e-commerce platform.

S304. Generate, according to the original image data and the attribute feature of the article, and the environment template, a display image in which the article is placed in the environment, and display the display image in the second article display interface. In the generated display image, the article is displayed from a main view angle. That is, without special setting, in the step, the display image with the displayed article as the main view angle is generated.

In addition, the user may further adjust the view angle in the second article display interface. Correspondingly, the method may further include: regenerating, in response to a view angle adjustment operation of the user in the second article display interface, a display image in which the article is displayed in the environment at an adjusted view angle, and displaying the display image in the second article display interface.

According to the article display processing method of this embodiment, a to-be-displayed article is fused with a preset environment template for article display, to allow a user to efficiently observe a display effect of the article in an environment. In a user interaction process, the user may configure an attribute feature and a matched environment template of the article, to allow the user to obtain displayed content and a display effect that the user wants to see.

### Embodiment 6

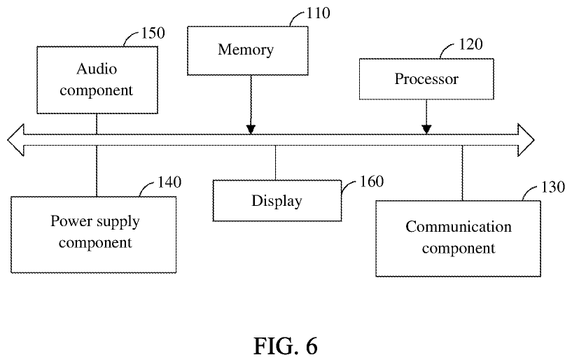

The process processing of the article display processing technology and the apparatus structure are described in the foregoing embodiments. The functions of the method and the apparatus may be completed by using an electronic device. FIG. 6 is a schematic structural diagram of an electronic device, according to an embodiment of this application. The electronic device specifically includes a memory 110 and a processor 120.

The memory 110 is configured to store a program.

In addition to the program, the memory 110 may be further configured to store other data to support operations on the electronic device. Examples of the data include instructions of any application program or method for operations on the electronic device, such as contact data, address book data, a message, a picture, and a video.

The memory 110 can be implemented by any type of volatile or non-volatile storage devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc.

The processor 120 is coupled to the memory 110 and configured to execute the program in the memory 110 to perform the operation steps of the article display processing method described in the foregoing embodiments.

In addition, the processor 120 may also include various modules described in the foregoing embodiments to perform article display processing. The memory 110 may be, for example, configured to store data required for and/or outputted by the modules performing the operations.

A detailed description of the processing process, a detailed description of the technical principles, and a detailed analysis of the technical effect are made in the foregoing embodiments. Details are not described herein again.

Further, as shown in the figure, the electronic device may further include: a communication component 130, a power supply component 140, an audio component 150, a display 160, and other components. Only some components are schematically shown in FIG., which does not mean that the electronic device includes only the components shown in the figure.

The communication component 130 is configured to facilitate communication between the electronic device and other devices in a wired or wireless manner. The electronic device may access a communication standard-based wireless network, such as WiFi, 2G, 3G, 4G/LTE, 5G, and other mobile communication networks, or a combination thereof. In an exemplary embodiment, the communication component 130 receives a broadcast signal or broadcast related information from an external broadcast management system via a broadcast channel. In an exemplary embodiment, the communication component 130 further includes a near field communication (NFC) module, to promote short-range communication. For example, the NFC module may be implemented based on a radio frequency identification (RFID) technology, an infra-red data association (IrDA) technology, an ultra-wideband (UWB) technology, a Bluetooth (BT) technology, and other technologies.

The power supply component 140 provides power for components of the electronic device. The power supply component 140 may include a power supply management system, one or more power supplies, and other components related to generation, management, and allocation of power for the electronic device.

The audio component 150 is configured to output and/or input an audio signal. For example, the audio component 150 includes a microphone (MIC). When the electronic device is in the operating mode, such as a call mode, a record mode, and a speech recognition mode, the microphone is configured to receive an external audio signal. The received audio signal may further be stored in the memory 110 or sent through the communication component 130. In some embodiments, the audio component 150 further includes a loudspeaker, configured to output an audio signal.

The display 160 includes a screen, which may include a liquid crystal display (LCD) and a touch panel (TP). If the screen includes a TP, the screen may be implemented as a touchscreen to receive an input signal from the user. The touch panel includes one or more touch sensors to sense a touch, a slide, and a gesture on the touch panel. The touch sensor may not only sense the boundary of touching or sliding operations, but also detect duration and pressure related to the touching or sliding operations.

A person of ordinary skill in the art may understand that all or some of the steps of the method embodiments may be implemented by a program instructing relevant hardware. The program may be stored in a computer-readable storage medium. When the program is executed, steps of the method embodiments are performed. The foregoing storage medium includes: a medium such as a ROM, a RAM, a magnetic disk, or an optical disc that can store program code.

Finally, it should be noted that the foregoing embodiments are merely used for describing the technical solutions of this application, but are not intended to limit this application Although this application is described in detail with reference to the foregoing embodiments, a person of ordinary skill in the art should understand that, modifications may still be made to the technical solutions in the foregoing embodiments, or equivalent replacements may be made to some or all of the technical features; and these modifications or replacements will not cause the essence of corresponding technical solutions to depart from the scope of the technical solutions in the embodiments of this application.

What is claimed is:

1. An article display processing method, comprising:
displaying a plurality of articles on a webpage, each of the plurality of articles being associated with an user interface;
receiving a user selection of the user interface associated with a selected article from a first user;
obtaining an environment template corresponding to the selected article, wherein the environment template is a digitally-generated simulated environment and stored in a database;
generating a display image comprising the environment template fused with the selected article as a main view angle according to feature data of the selected article; and
sending the display image to a client device of the first user for display.

2. The method according to claim 1, further comprising:
updating the display image when the first user changes the feature data of the selected article and/or the environment template, and displaying the updated display image.

3. The method according to claim 1, further comprising:
selecting, in response to a configuration operation of a second user on an article, one or more environment templates as environment templates matched with the article from an environment template database, wherein the environment templates respectively correspond to a plurality of different environment element combinations.

4. The method according to claim 3, further comprising:
after the one or more environment templates are selected as the environment templates matched with the article, generating a rendering file by fusing the article and each of the environment templates, and
wherein the generating a display image comprising the environment template fused with the selected article as a main view angle according to feature data of the selected article comprises: generating the display image with the selected article as the main view angle according to the feature data of the selected article, the environment template, and the rendering file.

5. The method according to claim 3, wherein the obtaining an environment template corresponding to the selected article comprises:
determining, according to the selected article, matched environment templates corresponding to the selected article; and
selecting the environment template from the matched environment templates for displaying the selected article.

6. The method according to claim 5, further comprising:
obtaining a new environment template in response to a change operation of the first user on one or more environment elements in the environment template, and displaying the selected article based on the new environment template, wherein the change operation on each of the one or more environment elements is performed within a corresponding range pre-configured by the second user.

7. The method according to claim 6, wherein the environment elements comprise hard furnishing environment elements and soft furnishing environment elements.

8. The method according to claim 1, wherein the environment template comprises an additional article different from the selected article, and the method further comprises:
displaying a display interface corresponding to the additional article in response to a selection operation of the first user on the additional article, and displaying a display image with the additional article as a main view angle in the display interface.

9. The method according to claim 8, further comprising:
rendering the additional article with feature data determined based on the feature data of the selected article.

10. The method according to claim 9, wherein the rendering comprises:
determining a color of the additional article based on a color of the selected article according to one or more predefined color schemes.

11. The method according to claim 1, wherein the webpage is displayed on the client device, and the sending the display image to a client device of the first user for display comprises:
generating a floating window on top of the webpage on the client device; and
displaying the display image in the floating window.

12. The method according to claim 1, wherein the webpage is displayed on a first client device, and the sending the display image to a client device of the first user for display comprises:
sending the display image to a second client device for display, wherein the second client device is different from the first client device.

13. A non-transitory computer-readable storage medium configured with instructions executable by one or more processors to cause the one or more processors to perform operations comprising:
displaying a plurality of articles on a webpage, each of the plurality of articles being associated with an user interface;
receiving a user selection of the user interface associated with a selected article from a first user;
obtaining an environment template corresponding to the selected article, wherein the environment template is a digitally-generated simulated environment and stored in a database;
generating a display image comprising the environment template fused with the selected article as a main view angle according to feature data of the selected article; and
sending the display image to a client device of the first user for display.

14. The non-transitory computer-readable storage medium of claim 13, wherein the operations further comprise:
updating the display image when the first user changes the feature data of the selected article and/or the environment template, and displaying the updated display image.

15. The non-transitory computer-readable storage medium of claim 13, wherein the operations further comprise:
selecting, in response to a configuration operation of a second user on an article, one or more environment templates as environment templates matched with the article from an environment template database, wherein the environment templates respectively correspond to a plurality of different environment element combinations.

16. The non-transitory computer-readable storage medium of claim 15, wherein the operations further comprise:
after the one or more environment templates are selected as the environment templates matched with the article, generating a rendering file by fusing the article and each of the environment templates, and
wherein the generating a display image comprising the environment template fused with the selected article as a main view angle according to feature data of the selected article comprises: generating the display image with the selected article as the main view angle according to the feature data of the selected article, the environment template, and the rendering file.

17. The non-transitory computer-readable storage medium of claim 15, wherein the obtaining an environment template corresponding to the selected article comprises:
determining, according to the selected article, matched environment templates corresponding to the selected article; and
selecting the environment template from the matched environment templates for displaying the selected article.

18. The non-transitory computer-readable storage medium of claim 17, wherein the operations further comprise:
obtaining a new environment template in response to a change operation of the first user on one or more environment elements in the environment template, and displaying the selected article based on the new environment template, wherein the change operation on each of the one or more environment elements is performed within a corresponding range pre-configured by the second user.

19. The non-transitory computer-readable storage medium of claim 13, wherein the environment template comprises an additional article different from the selected article, and the operations further comprise:
displaying a display interface corresponding to the additional article in response to a selection operation of the first user on the additional article, and displaying a display image with the additional article as a main view angle in the display interface.

20. A system comprising one or more processors and one or more non-transitory computer-readable storage media storing instructions executable by the one or more processors to cause the system to perform operations comprising:
displaying a plurality of articles on a webpage, each of the plurality of articles being associated with an user interface;
receiving a user selection of the user interface associated with a selected article from a first user;
obtaining an environment template corresponding to the selected article, wherein the environment template is a digitally-generated simulated environment and stored in a database;
generating a display image comprising the environment template fused with the selected article as a main view angle according to feature data of the selected article; and
sending the display image to a client device of the first user for display.
